(19) United States
(12) Patent Application Publication
(10) Pub. No.: US 2011/0107157 A1
(43) Pub. Date: May 5, 2011

(54) REGISTER ACCESS CONTROL METHOD AND CIRCUIT

(75) Inventors: Akira OKAMOTO, Kawasaki (JP); Seiji Satta, Kawasaki (JP); Toshikazu Ueki, Kawasaki (JP); Takashi Yamamoto, Kawasaki (JP)

(73) Assignee: FUJITSU LIMITED, Kawasaki-shi (JP)

(21) Appl. No.: 12/915,555

(22) Filed: Oct. 29, 2010

(30) Foreign Application Priority Data
Nov. 2, 2009 (JP) 2009-251737

(51) Int. Cl. G06F 12/00; G06F 11/07

(52) U.S. Cl. 714/49; 711/154; 711/E12.001; 714/E11.024

(57) ABSTRACT

A register access control circuit and method includes extracting data written to a plurality of registers by specifying the common address in response to read access to a common address, comparing the data extracted from the respective registers, and outputting the data extracted from one of the registers as read data when the data extracted from the respective registers match.

### CROSS-REFERENCE TO RELATED APPLICATIONS

This application is based upon and claims the benefit of priority of the prior Japanese Patent Application No. 2009-251737, filed on Nov. 2, 2009, the entire contents of which are incorporated herein by reference.

### FIELD

Embodiments of the invention discussed herein relate to register access control methods and register access control circuits for controlling access to a plurality of registers.

### BACKGROUND

FIG. 4 illustrates a configuration of a system in a related art where access control for a plurality of registers is executed.

A system 100 illustrated in FIG. 4 includes system boards 110 on each of which a plurality of central processing units (CPUs) are mounted, input/output (I/O) boards 120 on each of which a large-scale integrated circuit (LSI) that controls I/O is mounted, a crossbar board 130 on which crossbar chips (XBs) that control communication with the CPUs on the system boards 110 and with the I/O boards 120 are mounted, and a system management board 140 on which firmware that manages the system 100 is mounted.

When the system 100 starts up, the system management board 140 accesses registers in each of chips on the system boards 110, the I/O boards 120 and the crossbar board 130 via inter-integrated circuit (I2C) buses.

An example of access control is as follows. First, the system management board 140 specifies a slave address and channel of an I2C multiplexer 115, which is a higher-level device of the system board 110, to connect with a board (e.g., crossbar board 130) on which a target chip that the system management board 140 wants to access is mounted. Next, the system management board 140 specifies the slave address of the target chip and a register address within the target chip, and enables write access or read access to a target register.

After making write access to the target register, the system management board 140 enables read access to the same register. Then, after making sure that the written data matches the read data, the system management board 140 executes control such that the process proceeds to the next step.

For better access efficiency, the system 100 that uses low-speed buses such as I2C buses is demanded to reduce the time necessary for system start-up.

To meet such a demand, write access control which assigns a common address to a plurality of registers of substantially the same specifications so as to allow write access to the registers with the common address is known.

Japanese Unexamined Patent Application Publication No. 2000-132491 discloses a technique related to access control.

An example of read access control for a plurality of registers will be described.

FIG. 5 illustrates a configuration of a chip 9 mounted on the system 100 illustrated in FIG. 4.

The chip 9 includes a plurality of registers 90 of the same specifications. The chip 9 illustrated in FIG. 5 includes four registers 90_0, 90_1, 90_2, and 90_3. The registers 90_0, 90_1, 90_2, and 90_3 are assigned addresses 0x0000, 0x0100, 0x0200, and 0x0300, respectively.

Data stored in the registers 90_0, 90_1, 90_2, and 90_3 of the chip 9 is written or read by the process illustrated in FIG. 6 and FIG. 7.

In write control, the system management board 140 enables write access to the addresses of the respective registers 90_0, 90_1, 90_2, and 90_3 mounted on the chip 9 (S900 of FIG. 6). In response to the write access from the system management board 140, the chip 9 writes data to a register corresponding to a write-accessed address, that is, to one of the registers 90_0, 90_1, 90_2, and 90_3 (S901).

When the system management board 140 enables write access to the address 0x0000, the chip 9 writes data to the register 90_0 corresponding to the address 0x0000. When the system management board 140 enables write access to the address 0x0100, the chip 9 writes data to the register 90_1 corresponding to the address 0x0100. Likewise, in the cases of write access to the addresses 0x0200 and 0x0300, the chip 9 writes data to the registers 90 corresponding to these addresses.

To write the same data to the registers 90_0, 90_1, 90_2, and 90_3, the system management board 140 enables write access to each of their addresses 0x0000, 0x0100, 0x0200, and 0x0300.

In read control, the system management board 140 enables read access to the address 0x0000 (S902). In response to the read access from the system management board 140, the chip 9 reads data from the register 90_0 corresponding to the address 0x0000 (S903).

Next, the system management board 140 compares the data written to the register 90_0 with the data read from the register 90_0 (S904). If the data written to the register 90_0 matches the data read from the register 90_0 (YES in S905), the system management board 140 enables read access to the next address 0x0100 (S906). If the data written to the register 90_0 does not match the data read from the register 90_0 (NO in S905), the process proceeds to S918 of FIG. 7.

In response to the read access to the address 0x0100, the chip 9 reads data from the register 90_1 corresponding to the address 0x0100 (S907).

The system management board 140 compares the data written to the register 90_1 with the data read from the register 90_1 (S908). If the data written to the register 90_1 matches the data read from the register 90_1 (YES in S909), the system management board 140 enables read access to the next address 0x0200 (S910 of FIG. 7).

If the data written to the register 90_1 does not match the data read from the register 90_1 (NO in S909), the process proceeds to S918 of FIG. 7.

In response to the read access to the address 0x0200, the chip 9 reads data from the register 90_2 corresponding to the address 0x0200 (S911).

The system management board 140 compares the data written to the register 90_2 with the data read from the register 90_2 (S912). If the data written to the register 90_2 matches the data read from the register 90_2 (YES in S913), the system management board 140 enables read access to the next address 0x0300 (S914).

If the data written to the register 90_2 does not match the data read from the register 90_2 (NO in S913), the process proceeds to S918.

In response to the read access to the address 0x0300, the chip 9 reads data from the register 90_3 corresponding to the address 0x0300 (S915).

The system management board 140 compares the data written to the register 90_3 with the data read from the register 90_3 (S916). If the data written to the register 90_3 matches the data read from the register 90_3 (YES in S917), the system management board 140 performs the next register access control for another register.

If the data written to the register 90_3 does not match the data read from the register 90_3 (NO in S917), the process proceeds to S918.

In S918, the system management board 140 determines whether the number of access retries is less than a specified value (S918). If the number of access retries is less than the specified value (YES in S918), the process returns to S900, where the system management board 140 enables write access to the address of each of the registers 90. If the number of access retries reaches the specified value (NO in S918), the process proceeds to error processing.

As described above, even when data written to a plurality of registers is read, read access to each of the registers is enabled. Additionally, each time read access is enabled, data read from the register is compared with data (write data) written to the register.

### SUMMARY

In one aspect of the invention, a register access control method includes extracting data written to a plurality of registers by specifying the common address in response to read access to a common address, comparing the data extracted from the respective registers, and outputting the data extracted from one of the registers as read data if the data extracted from the respective registers match.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a register access control circuit according to an embodiment.

FIG. 2 illustrates a configuration of processing circuits for write access control in the register access control circuit.

FIG. 3 illustrates a flow of control in the register access control circuit.

FIG. 4 illustrates a configuration of a system in a related art where access control for a plurality of registers is executed.

FIG. 5 illustrates a configuration of a register access control circuit that performs read access control for a plurality of registers.

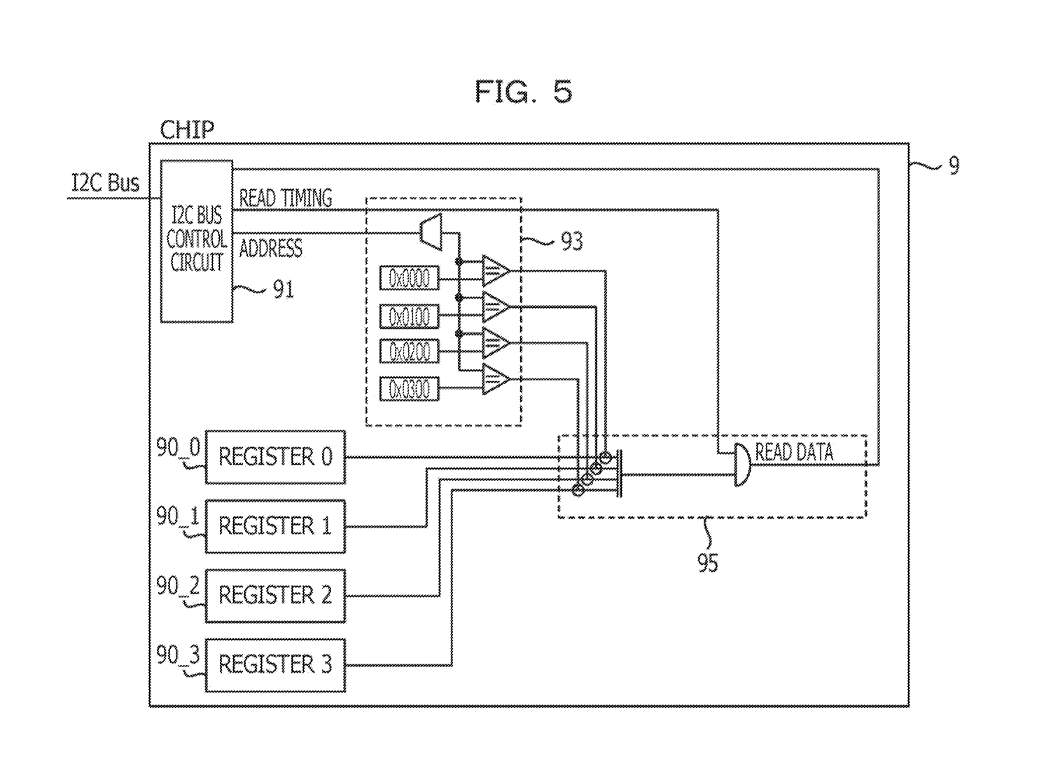

FIG. 6 illustrates a flow of read access control for a plurality of registers.

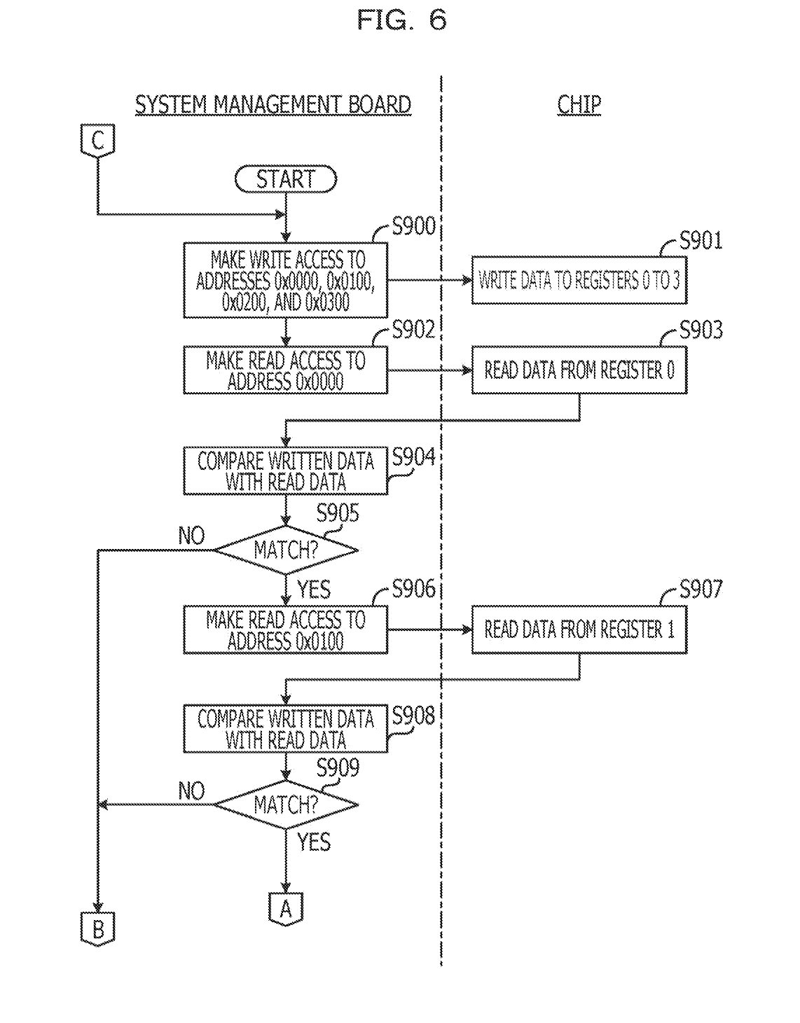

FIG. 7 illustrates a flow of read access control for a plurality of registers.

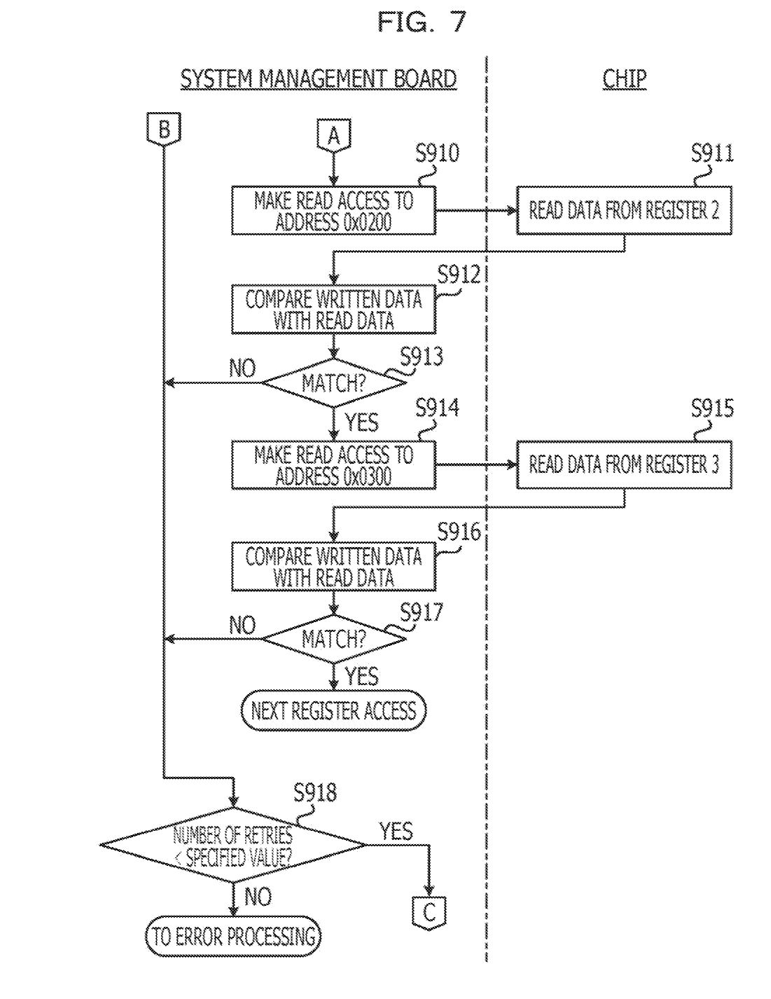

### DESCRIPTION OF EMBODIMENTS

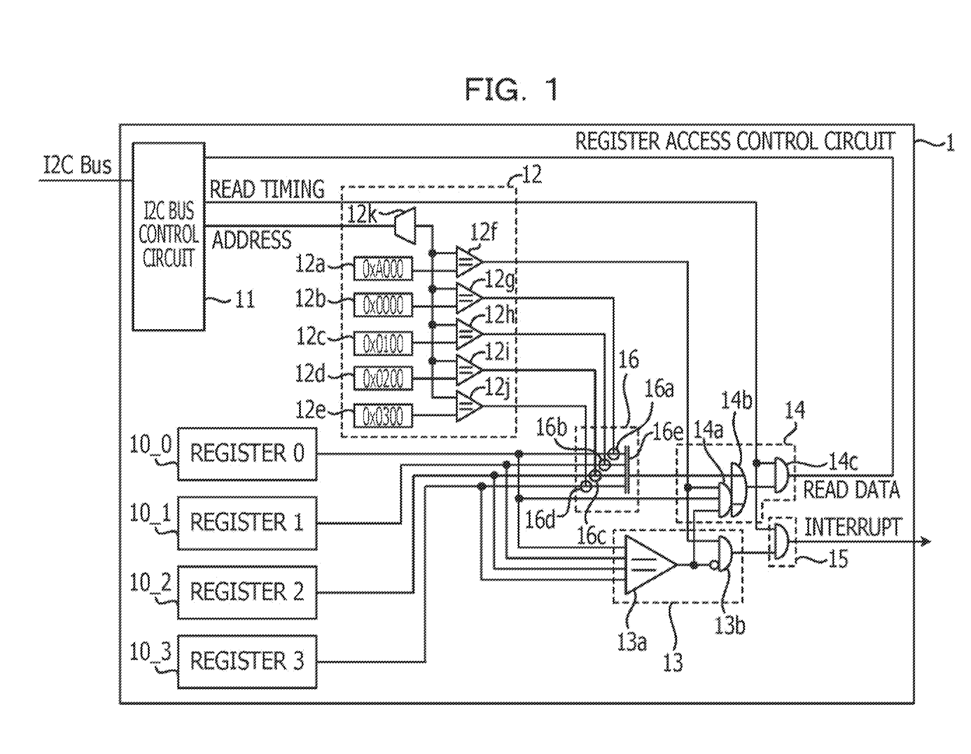

FIG. 1 illustrates a configuration of a register access control circuit 1 according to an embodiment of the present invention. In the present embodiment, four registers are mounted on the register access control circuit, although any number of registers may be used.

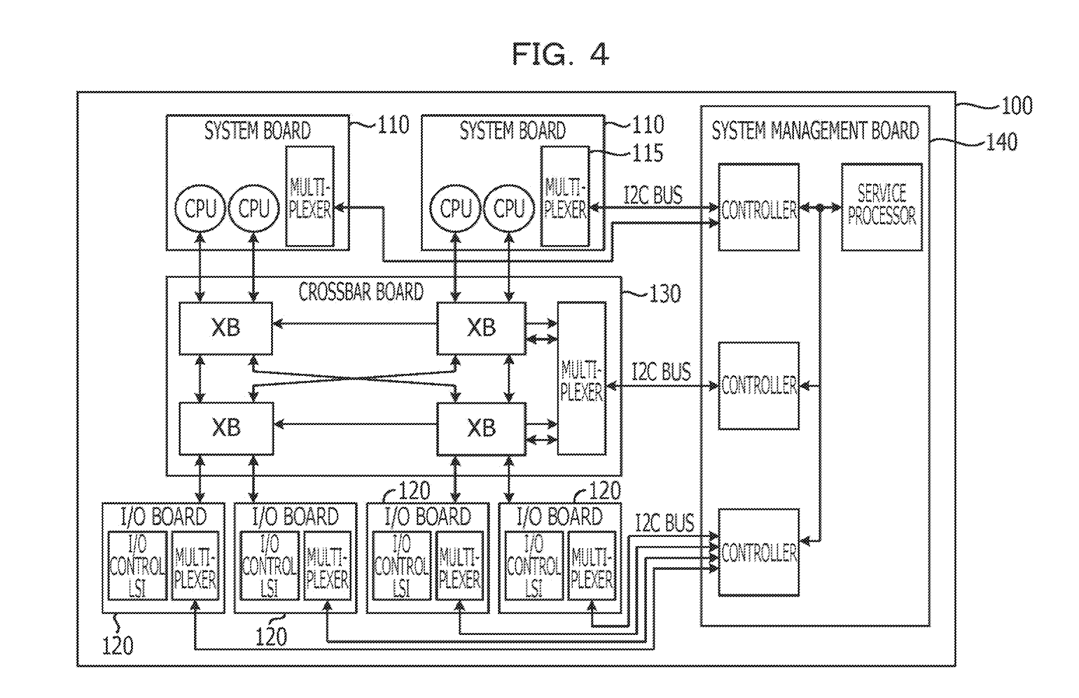

A register access control circuit 1 illustrated in FIG. 1 is a circuit mounted on a board. In the example of FIG. 1, the register access control circuit 1 is configured as a single chip, although any number of chips may be used. For example, the register access control circuit 1 is mounted on a chip on each board of a system having the configuration illustrated in FIG. 4.

The register access control circuit 1 includes processing circuits related to read access control, such as a plurality of registers 10_0, 10_1, 10_2, and 10_3, an I2C-bus control circuit 11, an address comparison circuit 12, a read-data comparison circuit 13, a read-data output circuit 14, an error output circuit 15, and a data selection circuit 16.

The registers 10_0, 10_1, 10_2, and 10_3 are registers of substantially the same specifications. Each of the registers is assigned not only an individual address, but also a common address common to all the registers.

The I2C-bus control circuit 11 accepts read access or write access to the registers 10_0, 10_1, 10_2, and 10_3. Then, the I2C-bus control circuit 11 controls reading of data held by the registers 10_0, 10_1, 10_2, and 10_3, or writing of data to the registers 10_0, 10_1, 10_2, and 10_3.

The address comparison circuit 12 identifies an address of a write-accessed register or an address of a read-accessed register. That is, the address comparison circuit 12 identifies a common address or individual addresses of the registers 10_0, 10_1, 10_2, and 10_3.

The address comparison circuit 12 includes, for example, a register 12a that holds a common address 0xA000 assigned in common to the four registers 10; registers 12b, 12c, 12d, and 12e that hold individual addresses 0x0000, 0x0100, 0x0200, and 0x0300 assigned to the registers 10_0, 10_1, 10_2, and 10_3, respectively; selection circuits 12f, 12g, 12h, 12i, and 12j; and a decoder 12k.

The selection circuits 12f, 12g, 12h, 12i, and 12j correspond to the registers 12a, 12b, 12c, 12d, and 12e, respectively. The selection circuits 12f, 12g, 12h, 12i, and 12j each compare an address held by the corresponding register 12a, 12b, 12c, 12d, or 12e with an address input from the I2C-bus control circuit 11. If these addresses match, the selection circuit 12f, 12g, 12h, 12i, or 12j outputs a select signal indicating the address of the corresponding register.

The selection circuit 12f compares an address input from the I2C-bus control circuit 11 with the common address 0xA000 held by the corresponding register 12a. If the two addresses match, the selection circuit 12f outputs a select signal indicating the common address 0xA000 which is a read access target. The select signal output from the selection circuit 12f is input to the read-data comparison circuit 13 and the read-data output circuit 14.

The selection circuit 12g compares an address input from the I2C-bus control circuit 11 with the individual address 0x0000 of the register 10_0, the individual address 0x0000 being held by the corresponding register 12b. If the two addresses match, the selection circuit 12g outputs a select signal indicating the address 0x0000 of the register 10_0 which is a read access target. The selection circuits 12h, 12i, and 12j operate in substantially the same manner as the selection circuit 12g. Specifically, if an address input from the I2C-bus control circuit 11 matches the address held by the corresponding register 12 (12c, 12d, or 12e), the selection circuit 12h, 12i, or 12j outputs a select signal indicating the address (0x0100, 0x0200, or 0x0300) that indicates that the read access target is its corresponding register 10 (register 10_1, 10_2, or 10_3).

The select signal output from the selection circuit 12g, 12h, 12i, or 12j is input to the data selection circuit 16.

The decoder 12k decodes an address signal input from the I2C-bus control circuit 11 and outputs the decoded address to the selection circuits 12f, 12g, 12h, 12i, and 12j.

The read-data comparison circuit 13 compares data written to the respective registers 10_0, 10_1, 10_2, and 10_3.

The read-data comparison circuit 13 includes, for example, a data comparison circuit 13a and an error signal circuit 13b.

The data comparison circuit 13a compares data written to the respective registers 10_0, 10_1, 10_2, and 10_3. Only when all the four data match, the data comparison circuit 13a outputs a select signal indicating that the data written to the four registers match.

The select signal output from the data comparison circuit 13a is input to the error signal circuit 13b and the read-data output circuit 14.

The error signal circuit 13b is a two-input AND gate that inputs a select signal from the selection circuit 12f and a signal obtained by inverting a signal output from the data comparison circuit 13a. When the data comparison circuit 13a does not output a select signal, the error signal circuit 13b outputs an error signal indicating that the data written to the four registers 10_0, 10_1, 10_2, and 10_3 do not match.

The error signal output from the error signal circuit 13b is input to the error output circuit 15.

When an output of the read-data comparison circuit 13 indicates that all the data extracted from the respective registers 10_0, 10_1, 10_2, and 10_3 match, the read-data output circuit 14 outputs the data extracted from the register 10_0 as read data. When the read access target is the individual address of one of the registers 10_0, 10_1, 10_2, and 10_3, the read-data output circuit 14 outputs the data extracted from the register 10 corresponding to this individual address as read data.

The read-data output circuit 14 includes, for example, a common-address-data acquisition circuit 14a, a data selection circuit 14b, and a data output circuit 14c.

The common-address-data acquisition circuit 14a is a three-input AND gate, to which a select signal from the data comparison circuit 13a of the read-data comparison circuit 13 and a select signal from the selection circuit 12f of the address comparison circuit 12 are input. When the signals input to the common-address-data acquisition circuit 14a are effective, the common-address-data acquisition circuit 14a outputs the data written to the register 10_0.

The data selection circuit 14b is a two-input OR gate. The data selection circuit 14b outputs, to the data output circuit 14c, the data output from the common-address-data acquisition circuit 14a (i.e., the data written to the register 10_0) or data output from the data selection circuit 16.

The data output circuit 14c outputs the data output from the data selection circuit 14b to the I2C-bus control circuit 11 as read data, in accordance with a read timing signal output from the I2C-bus control circuit 11.

The error output circuit 15 outputs an interrupt signal indicating a read access error when at least one of the data extracted from the registers 10_0, 10_1, 10_2, and 10_3 does not match the others. The error output circuit 15 is, for example, a two-input AND gate. The error output circuit 15 outputs an interrupt signal when an error signal output from the error signal circuit 13b of the read-data comparison circuit 13 and a read timing signal output from the I2C-bus control circuit 11 are input.

When the read access target is the individual address of one of the registers 10_0, 10_1, 10_2, and 10_3, the data selection circuit 16 selects one of the registers 10_0, 10_1, 10_2, and 10_3 in accordance with a select signal indicating this individual address, the select signal being output from the address comparison circuit 12. Then, the data selection circuit 16 outputs the data written to the selected register 10 to the read-data output circuit 14.

The data selection circuit 16 includes, for example, comparison circuits 16a, 16b, 16c, and 16d and a selection circuit 16e.

The comparison circuit 16a corresponds to the register 10_0. When a select signal output from the selection circuit 12g of the address comparison circuit 12 matches the address of the corresponding register 10_0, the comparison circuit 16a extracts the data written to the register 10_0 and outputs the extracted data to the selection circuit 16e. Similarly, the comparison circuits 16b, 16c, and 16d correspond to the registers 10_1, 10_2, and 10_3, respectively. When a select signal output from the selection circuit 12h, 12i, or 12j of the address comparison circuit 12 matches the address of the corresponding register 10, the comparison circuit 16b, 16c, or 16d extracts the data written to the corresponding register 10_1, 10_2, or 10_3 and outputs the extracted data to the selection circuit 16e.

The selection circuit 16e inputs data from any of the comparison circuits 16a, 16b, 16c, and 16d and outputs the data to the read-data output circuit 14.

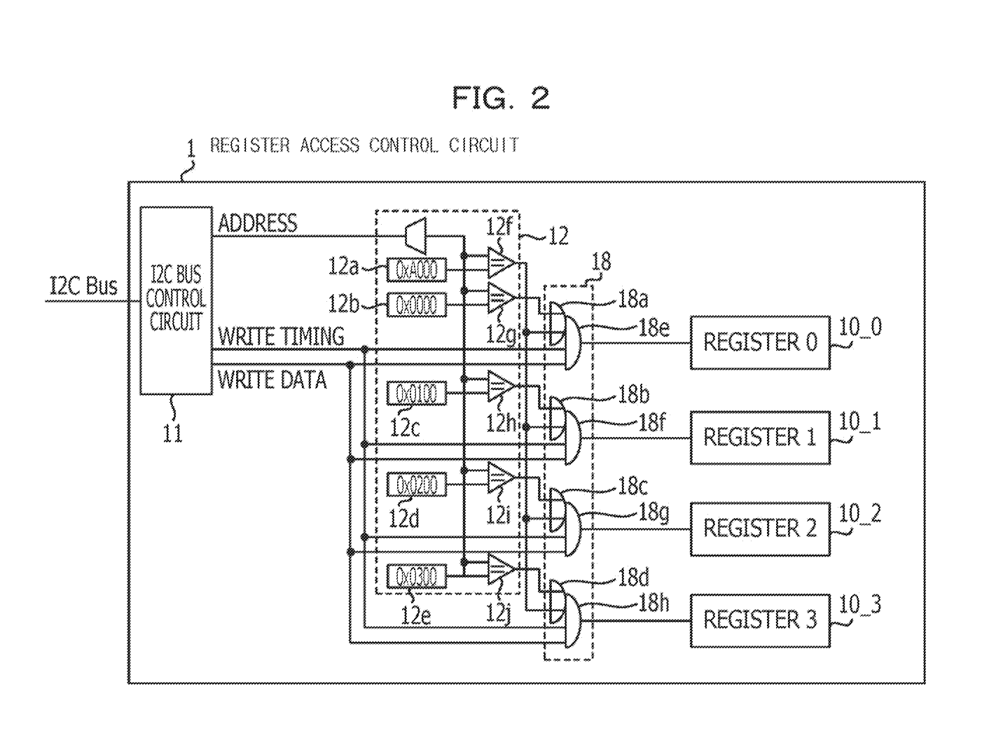

FIG. 2 illustrates a configuration of processing circuits related to write access control in the register access control circuit 1.

The register access control circuit 1 includes the registers 10_0, 10_1, 10_2, and 10_3, the address comparison circuit 12, and a data writing circuit 18.

The registers 10_0, 10_1, 10_2, and 10_3 and the address comparison circuit 12 may be the same as those illustrated in FIG. 1.

The data writing circuit 18 includes write-data selection circuits 18a, 18b, 18c, and 18d and writing circuits 18e, 18f, 18g, and 18h.

In write access control, a select signal output from the selection circuit 12f of the address comparison circuit 12 is input to the write-data selection circuits 18a, 18b, 18c, and 18d. A select signal output from the selection circuit 12g is input to the write-data selection circuit 18a, and a select signal output from the selection circuit 12h is input to the write-data selection circuit 18b. Also, a select signal output from the selection circuit 12i is input to the write-data selection circuit 18c, and a select signal output from the selection circuit 12j is input to the write-data selection circuit 18d.

As write data, the write-data selection circuits 18a, 18b, 18c, and 18d output data received from the I2C-bus control circuit 11 to the writing circuits 18e, 18f, 18g, and 18h, respectively. The write data corresponds to either a select signal output from the selection circuit 12f or a select signal output from one of the selection circuits 12g, 12h, 12i, and 12j. The select signal from the selection circuit 12f indicates the common address of the registers 10 as a write access target, while the select signal from one of the selection circuits 12g, 12h, 12i, and 12j indicates the individual address of the corresponding register 10 as a write access target.

The writing circuits 18e, 18f, 18g, and 18h write the data output from the respective write-data selection circuits 18a, 18b, 18c, and 18d to the corresponding registers 10_0, 10_1, 10_2, and 10_3.

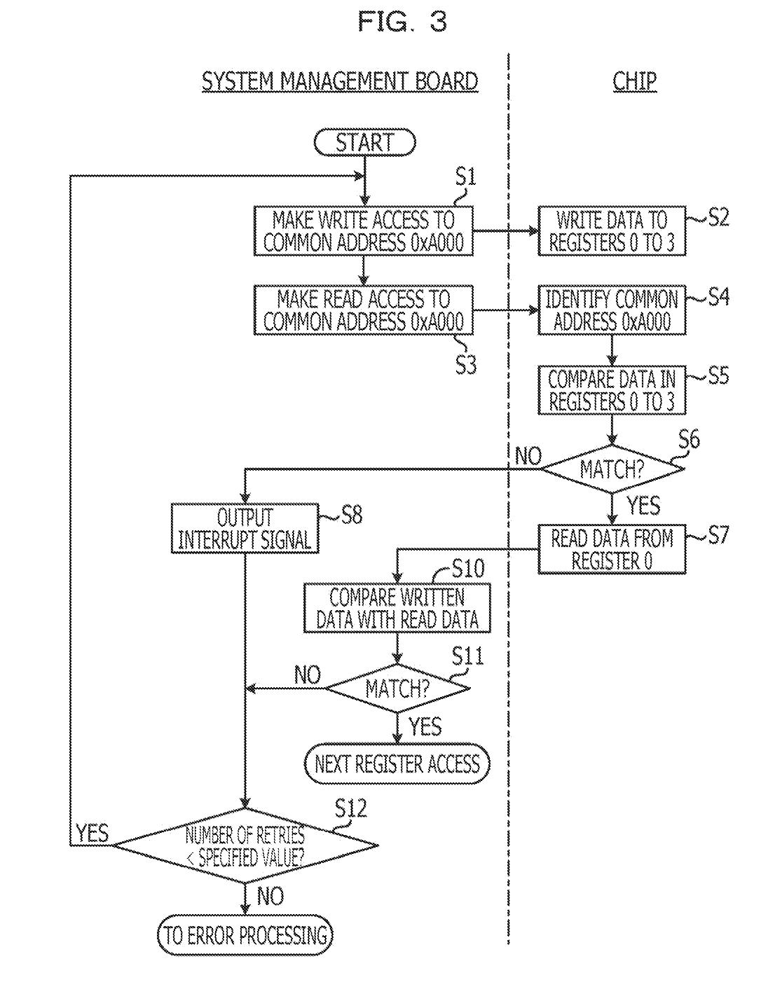

FIG. 3 illustrates a flow of control executed in the register access control circuit 1 mounted on a board included in the system 100 of FIG. 4.

The system management board 140 enables write access to the common address 0xA000 of the registers 10_0, 10_1, 10_2, and 10_3 (S1).

The register access control circuit 1 accepts the write access from the system management board 140, and writes write data to the registers 10_0, 10_1, 10_2, and 10_3 to which the common address 0xA000 is assigned (S2).

Here, as illustrated in FIG. 2, the selection circuit 12f of the address comparison circuit 12 compares an address received from the I2C-bus control circuit 11 with the common address 0xA000 held by the register 12a. If the two addresses match, the selection circuit 12f outputs a select signal indicating the common address to the write-data selection circuits 18a, 18b, 18c, and 18d of the data writing circuit 18.

When the select signal from the selection circuit 12f is input, the write-data selection circuits 18a, 18b, 18c, and 18d each output a write signal to their corresponding writing circuits 18e, 18f, 18g, and 18h.

When the write signal is input from the write-data selection circuit 18a, the writing circuit 18e writes the write data received from the I2C-bus control circuit 11 to the corresponding register 10_0 in accordance with a write timing signal output from the I2C-bus control circuit 11. The other writing circuits 18f, 18g, and 18h operate in substantially the same manner as the writing circuit 18e, and write the write data received from the I2C-bus control circuit 11 to their corresponding registers 10.

By simply accepting a single write access to the common address 0xA000 assigned in common to the plurality of registers 10_0, 10_1, 10_2, and 10_3, the register access control circuit 1 writes the write data to all the registers 10_0, 10_1, 10_2, and 10_3 at a time.

Then, the system management board 140 enables read access to the common address 0xA000 of the registers 10_0, 10_1, 10_2, and 10_3 (S3).

When the I2C-bus control circuit 11 of the register access control circuit 1 accepts the read access from the system management board 140 to the common address 0xA000, the address comparison circuit 12 receives the address output from the I2C-bus control circuit 11. The address comparison circuit 12 identifies the received address as the common address 0xA000 of the registers 10_0, 10_1, 10_2, and 10_3 (S4). The selection circuit 12f of the address comparison circuit 12 compares the address received from the I2C-bus control circuit 11 with the common address 0xA000 held by the register 12a. If the two addresses match, the selection circuit 12f outputs a select signal indicating the common address 0xA000.

The read-data comparison circuit 13 extracts the data written to the registers 10_0, 10_1, 10_2, and 10_3, compares the extracted data (S5), and determines whether the extracted data match (S6). If all the data extracted from the registers 10_0, 10_1, 10_2, and 10_3 match, the data comparison circuit 13a of the read-data comparison circuit 13 outputs a select signal indicating that the data written to all the registers 10 match.

When the read access target is the common address 0xA000, if the comparison result output from the read-data comparison circuit 13 indicates that all the data extracted from the registers 10_0, 10_1, 10_2, and 10_3 match (YES in S6), the read-data output circuit 14 outputs the data extracted from the register 10_0 as read data (S7). Specifically, when the select signal is input from the data comparison circuit 13a, the common-address-data acquisition circuit 14a of the read-data output circuit 14 extracts the data written to the register 10_0 and outputs the extracted data to the data selection circuit 14b.

If the comparison result output from the read-data comparison circuit 13 indicates that not all the data extracted from the registers 10_0, 10_1, 10_2, and 10_3 match (NO in S6), the error output circuit 15 outputs an interrupt signal indicating a read access error (S8). When the data comparison circuit 13a does not output a select signal while the selection circuit 12f of the address comparison circuit 12 outputs a select signal, the error signal circuit 13b outputs an error signal. As described above, a signal obtained by inverting a signal output from the data comparison circuit 13a is input to the error signal circuit 13b.

When the read data is transmitted from the register access control circuit 1, the system management board 140 receives the transmitted read data and compares the write data written in S2 with the read data received from the register access control circuit 1 (S10). If the write data and the read data match (YES in S11), the next register access is executed. If the write data and the read data do not match (NO in S11), the system management board 140 determines whether the number of access retries is less than a specified value (S12). If the number of access retries is less than the specified value (YES in S12), the process returns to 51, where the system management board 140 executes write access. If the number of access retries reaches the specified value (NO in S12), the process proceeds to error processing.

When an interrupt signal is output from the register access control circuit 1 (S8), the system management board 140 also determines whether the number of access retries is less than the specified value (S12). In accordance with the determination in S12, the system management board 140 executes write access (S1) or error processing.

When the I2C-bus control circuit 11 of the register access control circuit 1 accepts read access to an individual address assigned to one of the registers 10, the selection circuit 12g, 12h, 12i, or 12j of the address comparison circuit 12 outputs a select signal indicating the individual address of its corresponding register if this individual address matches the address received from the I2C-bus control circuit 11.

When the select signal is input from the address comparison circuit 12, the comparison circuit 16a, 16b, 16c, or 16d of the data selection circuit 16 compares the address of its corresponding register 10 with the address indicated by the input select signal. When the two addresses match, the comparison circuit 16a, 16b, 16c, or 16d outputs data written to the corresponding register 10 to the selection circuit 16e. The selection circuit 16e outputs the data input from the comparison circuit 16a, 16b, 16c, or 16d to the read-data output circuit 14.

For example, if an address received by the I2C-bus control circuit 11 of the register access control circuit 1 is the individual address 0x0000 of the register 10_0, the address received by the selection circuit 12g of the address comparison circuit 12 matches the individual address held by the register 12b. Therefore, the selection circuit 12g outputs a select signal indicating the individual address 0x0000 to the comparison circuit 16a. The comparison circuit 16a compares the individual address indicated by the select signal input from the selection circuit 12g with the individual address 0x0000 of the corresponding register 10_0. If the two addresses match, the comparison circuit 16a outputs data written to the register 10_0 to the selection circuit 16e.

As described in the embodiment above, access efficiency can be improved since the register access control circuit 1 can enable write access and read access to a plurality of registers of substantially the same specifications at a time. It is thus possible to reduce the start-up time of a system including a board on which the register access control circuit 1 is mounted.

The above description primarily discusses the case in which the present invention made by the present inventor is applied to register access control, which is the background art of the present invention. However, the present invention is not limited to this. It is to be understood that various modifications may be made within the scope of the description of the present invention.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A register access control method comprising:
extracting, in response to read access to a common address, data written to a plurality of registers by specifying the common address;
comparing the data extracted from the respective ones of the plurality of registers; and
outputting, when the data extracted from the respective registers match, the data extracted from one of the plurality of registers as read data.

2. The register access control method according to claim 1, further comprising:
outputting an interrupt signal indicating an error in the read access when the data extracted from the respective registers do not match.

3. A register access control circuit comprising:
a plurality of registers to which a common address is assigned;
a data extraction circuit configured to extract, in response to read access to a common address, data written to respective ones of the plurality of registers by specifying the common address;
a data comparison circuit configured to compare the data extracted from the respective registers; and
a read-data output circuit configured to output, when the data extracted from the respective registers match, the data extracted from one of the plurality of registers as read data.

4. The register access control circuit according to claim 3, further comprising an error output circuit configured to output an interrupt signal indicating an error in the read access when the data extracted from the respective registers do not match.
